(19) United States
(12) Patent Application Publication
(10) Pub. No.: US 2016/0201528 A1
(43) Pub. Date: Jul. 14, 2016

(54) Cylinder Head Cover

(71) Applicant: SANOH INDUSTRIAL CO., LTD., Tokyo (JP)

(72) Inventor: Hideki Nishikido, Koga-shi (JP)

(21) Appl. No.: 14/914,337

(22) PCT Filed: Oct. 17, 2014
(86) PCT No.: PCT/JP2014/077738

§ 371 Date: Feb. 25, 2016

(30) Foreign Application Priority Data
Nov. 21, 2013 (JP) 2013-241320

(51) Int. Cl. F01M 11/02; F01M 1/02; F01L 1/047; F02F 7/00

(52) U.S. Cl. CPC F01M 11/02; F02F 7/0043; F01M 1/02; F01L 1/047; F01M 2011/021

(57) ABSTRACT

A cylinder head cover includes: a cover section that covers a cylinder head, a pump casing section that is integrally formed with the cover section, that includes an upward-facing opening and that is provided with a circular hole portion that penetrates the cover section at a bottom portion; a rotation shaft that fits into the circular hole portion, with one axial direction end side disposed inside the pump casing section and with another end side coupled to a cam shaft; a vane that is disposed inside the pump casing section and that rotates integrally with the rotation shaft; and an oil supply path that extends from the pump casing section to the cover section, that is in communication with an oil flow path of the cylinder head, and that supplies oil pumped to the oil flow path from an oil pump to inside the pump casing section.

### TECHNICAL FIELD

The present invention relates to a cylinder head cover provided with a negative pressure pump.

### BACKGROUND ART

Japanese Patent Application Laid-Open (JP-A) No. 2004-92504 describes a vane-type negative pressure pump that is attached to a cylinder head cover of an engine. In this negative pressure pump, after attaching a casing with a bottomed tube shape to the cylinder head cover, a rotation shaft (rotor) and a cam shaft are coupled together through a through hole in a bottom portion of the casing using an Oldham coupling.

In the negative pressure pump described in JP-A No. 2004-92504, end portions of a circular tube shaped joint are respectively inserted into a through hole serving as an oil flow path formed inside the cam shaft, and a through hole serving as an oil flow path formed inside the rotation shaft, and oil pumped from the cam shaft is supplied inside the negative pressure pump through the joint and the rotation shaft.

### SUMMARY OF INVENTION

### Technical Problem

Sometimes the negative pressure pump is attached to the cylinder head cover in a state in which the engine has been installed in an engine room. In such cases, in structures in which the rotation shaft is disposed coaxially to the cam shaft, such as in the negative pressure pump described in JP-A No. 2004-92504, a gap between the engine and an inner wall face of the engine room is utilized when performing an operation to couple the rotation shaft to the cam shaft from beside the engine. Depending on the size of the gap, therefore, the operation to couple the rotation shaft to the cam shaft can sometimes become difficult.

In the negative pressure pump described in JP-A No. 2004-92504, since oil is pumped through a joint from the drive-rotation cam shaft to the driven-rotation rotation shaft, the oil supply structure tends to become complex.

An object of the present invention is to supply oil inside a negative pressure pump with a simple structure, while facilitating an operation to couple together a rotation shaft of a negative pressure pump and a cam shaft in a cylinder head cover provided with a negative pressure pump.

### Solution to Problem

A cylinder head cover of a first aspect of the present invention includes: a cover section that covers a cylinder head of an engine provided with a cam shaft; a pump casing section that has a bottomed tube shape, that is integrally formed with the cover section, that includes an upward-facing opening with the opening closed off by a lid body, and that is provided with a circular hole portion that penetrates the cover section at a position offset from a casing section center of a bottom portion; a rotation shaft that fits into the circular hole portion, with one axial direction end side of the rotation shaft disposed inside the pump casing section and with another axial direction end side of the rotation shaft coupled to the cam shaft, and that is rotated by motive power transmitted from the cam shaft; a vane that is disposed inside the pump casing section, that is supported by the rotation shaft so as to be capable of moving reciprocally along a direction orthogonal to the rotation shaft, that rotates integrally with the rotation shaft, that includes an end portion that slides across an inner wall face of the pump casing section, and that partitions the inside of the pump casing section into plural spaces; and an oil supply path that extends from the pump casing section to the cover section, that is in communication with an oil flow path formed at the cylinder head, and that supplies oil pumped to the oil flow path from an oil pump of the engine to inside the pump casing section.

In the cylinder head cover of the first aspect, when motive power is transmitted from the cam shaft to the rotation shaft, the vane rotates integrally with the rotation shaft. Due to this rotation, the vane moves along a direction orthogonal to the rotation shaft (direction of a diameter of the rotation shaft) under centrifugal force, and the end portion of the vane slides across the inner wall face of the pump casing section.

Due to fitting the rotation shaft into the circular hole portion that is offset from the casing section center, the center of rotation of the rotation shaft is at a position offset with respect to the casing section center (the center of the pump casing section). The volume of the spaces partitioned by the vane accordingly increases and decreases when the rotation shaft and the vane rotate together as a unit. In the spaces that increase and decrease in volume due to the vane, as the volume increases, gas is sucked in from the side of a device connected to a negative pressure pump, thereby filling the space with gas. As the volume decreases, the gas that has been sucked in is discharged from the space while being compressed, thereby enabling negative pressure to be generated on the device side.

A portion of the cylinder head cover is configured as a negative pressure pump by the pump casing section with the opening closed off by the lid body, the rotation shaft, and the vane.

In the cylinder head cover, the opening of the pump casing section faces upward, thereby enabling a large space above the engine to be utilized when performing an operation to couple the rotation shaft to the cam shaft. This thereby facilitates the coupling operation of the rotation shaft and the cam shaft.

In the cylinder head cover, oil pumped from the oil pump to the oil flow path can be supplied inside the pump casing section (negative pressure pump) through the oil supply path that extends from the pump casing section to the cover section. This thereby enables oil to be supplied inside the pump casing section with a simpler structure than in configurations in which, for example, oil is pumped through a joint from a drive-rotation cam shaft to a driven-rotation rotation shaft.

Due to the above, the cylinder head cover of the first aspect enables oil to be supplied inside a negative pressure pump with a simple structure, while facilitating the coupling operation of the rotation shaft of the negative pressure pump to the cam shaft.

In the cylinder head cover, the cover section that covers the cylinder head is integrally formed with the pump casing section configuring the negative pressure pump, thereby enabling a reduction in manufacturing costs in comparison to when the cover section and the pump casing section are manufactured as separate bodies.

A cylinder head cover of a second aspect of the present invention is the cylinder head cover of the first aspect in which, one end of the oil supply path opens onto a hole wall face of the circular hole portion, and another end of oil supply path opens onto a portion of the cover section that abuts the cylinder head and is in communication with the oil flow path.

In the cylinder head cover of the second aspect, the one end of the oil supply path opens onto the hole wall face of the circular hole portion, and oil is supplied between the rotation shaft and the circular hole portion, thereby enabling a reduction in frictional resistance between the rotation shaft and the circular hole portion. Wear between the rotation shaft and the hole wall face of the circular hole portion is accordingly suppressed. Moreover, the oil smooths rotation of the rotation shaft, thereby suppressing energy loss in the engine.

The other end of the oil supply path opens onto the portion of the cover section that abuts the cylinder head. Accordingly, the oil supply path and the oil flow path of the cylinder head can be placed in communication with each other by attaching the cover section to the cylinder head.

A cylinder head cover of a third aspect of the present invention is the cylinder head cover of either the first aspect or the second aspect in which, the other axial direction end side of the rotation shaft is provided with a driven side gear that meshes with a drive side gear provided at the cam shaft, and that couples the rotation shaft and the cam shaft together.

In the cylinder head cover of the third aspect, motive power (drive force) from the cam shaft is transmitted to the rotation shaft through the drive side gear and the driven side gear that are meshed together. Note that the rotation shaft and the cam shaft are coupled together by inserting the other axial direction end side of the rotation shaft into the circular hole portion of the pump casing section, and meshing the driven side gear together with the drive side gear of the cam shaft. This thereby further facilitates the operation to couple the rotation shaft and the cam shaft together.

### Advantageous Effects of Invention

The present invention enables oil to be supplied inside a negative pressure pump with a simple structure, while facilitating an operation to couple together a rotation shaft of the negative pressure pump and a cam shaft in a cylinder head cover provided with a negative pressure pump.

### BRIEF DESCRIPTION OF DRAWINGS

FIG. 1 is a perspective view of a cylinder head cover of an exemplary embodiment of the present invention.

FIG. 2 is an exploded perspective view of a negative pressure pump section of the cylinder head cover in FIG. 1.

FIG. 3 is a back face view of the cylinder head cover in FIG. 1, as viewed from a back face side.

FIG. 4 is a cross-section taken along line 4X-4X of the cylinder head cover in FIG. 3, and includes a separate enlarged view of the portion enclosed by the single-dotted dashed line.

FIG. 5 is a perspective view of the cylinder head cover in FIG. 1, as viewed from diagonally below, illustrating a coupled state of a rotation shaft and a cam shaft.

FIG. 6 is a back face view of the cylinder head cover in FIG. 1, as viewed from a back face side, illustrating a coupled state of a rotation shaft and a cam shaft.

FIG. 7 is a cross-section corresponding to FIG. 4 (a cross-section taken along line 4X-4X in FIG. 3), illustrating an attached state of a cylinder head cover to a cylinder head.

### DESCRIPTION OF EMBODIMENTS

Explanation follows regarding a cylinder head cover according to an exemplary embodiment of the present invention.

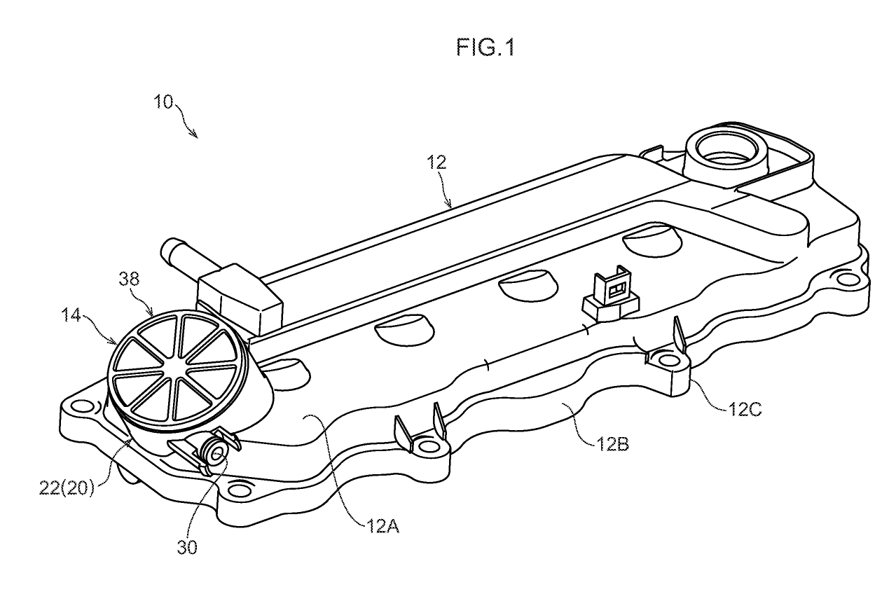

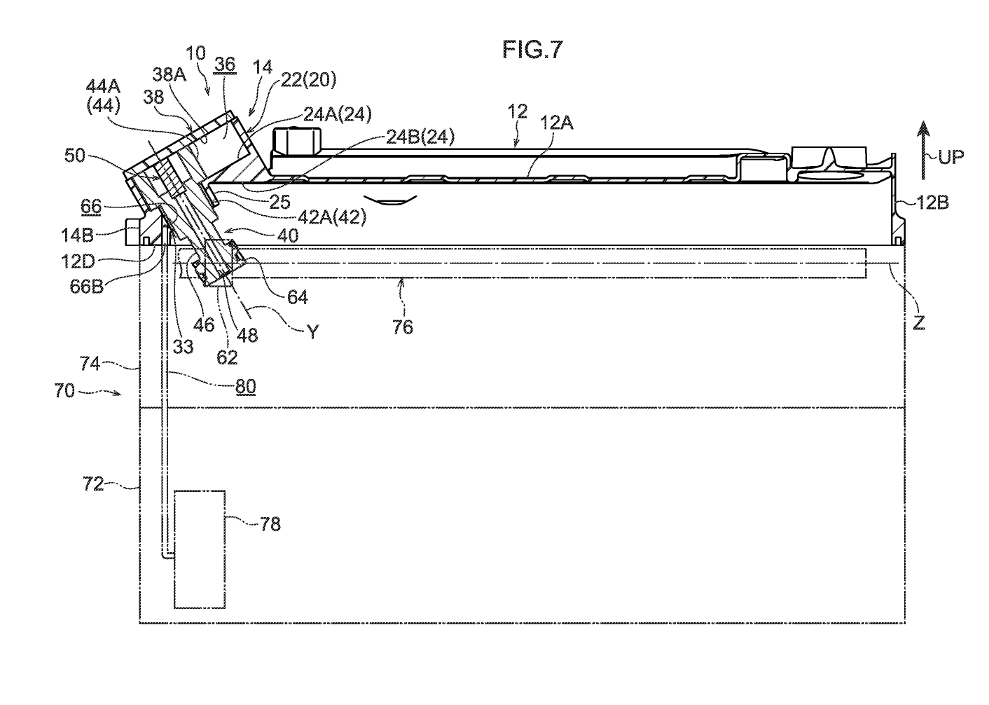

As illustrated in FIG. 1 and FIG. 7, a cylinder head cover 10 of the present exemplary embodiment includes a cover section 12 that covers a cylinder head 74 of an engine 70 and a cam shaft 76 provided to an upper portion of the cylinder head 74, a negative pressure pump section 14 that generates negative pressure using the engine 70 as a source of motive power, and an oil supply path 66 that supplies oil (engine oil in the present exemplary embodiment) pumped from an oil pump 78 of the engine 70 into a pump casing section 20.

As illustrated in FIG. 7, the engine 70 of the present exemplary embodiment has a standard configuration including a cylinder block 72, the cylinder head 74, a crank shaft (not illustrated in the drawings), a timing belt or a timing chain (not illustrated in the drawings), the cam shaft 76, and the oil pump 78.

A vehicle negative pressure-type brake booster (not illustrated in the drawings) is connected to the negative pressure pump section 14 of the present exemplary embodiment; however, the present invention is not limited thereto, and a device other than a negative pressure-type brake booster may be connected to the negative pressure pump section 14 as long as it is a device that utilizes negative pressure.

The arrow UP in the drawings indicates upward in the cylinder head cover 10 in a state in which the engine 70 is installed in an engine room. The arrow Y in the drawings indicates the axial center of a rotation shaft 40, described later, and an extension line thereof. The arrow Z indicates the axial center of a cam shaft 76 and an extension line thereof.

As illustrated in FIG. 1, the cover section 12 includes a top portion 12A, a peripheral wall portion 12B extending downward from an outer peripheral edge portion of the top portion 12A, and screw fixing portions 12C that project out from the peripheral wall portion 12B toward the outside and are fixed to the cylinder head 74 by screws. The pump casing section 20 is formed at the outer peripheral edge portion of the top portion 12A. A lower face 12D of the peripheral wall portion 12B contacts and is supported by an upper portion of the cylinder head 74 (see FIG. 7).

The cover section 12 is formed from resin. The resin used to form the cover section 12 may be the same as, or different from, a resin used to form the pump casing section 20. Note that in the present exemplary embodiment, the cover section 12 and the pump casing section 20 are an integrally formed product formed from the same resin.

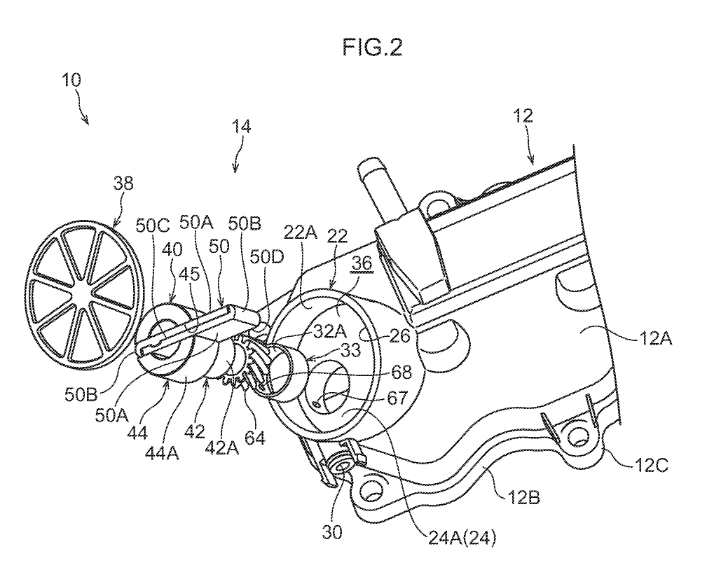

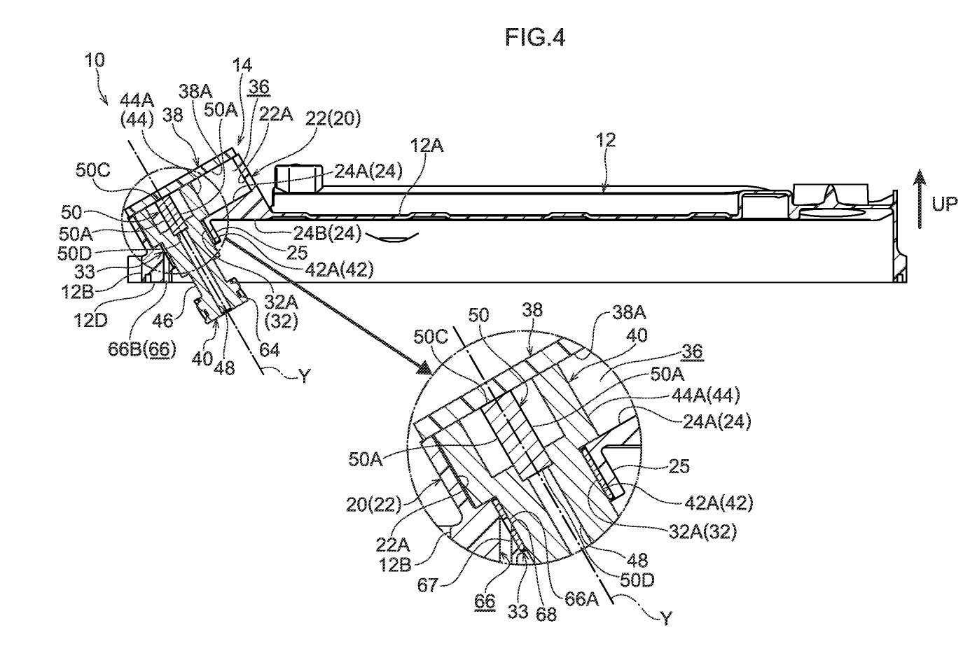

As illustrated in FIG. 2 and FIG. 4, the negative pressure pump section 14 is formed in a bottomed tube shape, and includes the pump casing section 20 with an opening 26 that is closed off by a lid body 38, the rotation shaft 40 with a support portion 44 disposed inside the pump casing section 20, and that transmits motive power from the cam shaft 76, and a vane 50 that is disposed inside the pump casing section 20 and that is supported by the support portion 44.

Note that in the present exemplary embodiment, “tube shaped” includes circular tube shapes, oval tube shapes (elliptical tube shapes), polygonal tube shapes with inside walls having a circular or oval (elliptical) cross-section profile, and composite tube shapes combining the aforementioned tube shapes. “Tube shaped” also includes tube shapes with an internal diameter that changes along the axial direction.

The pump casing section 20 has a tube shape with a bottom, and is configured including a tube shaped tube wall portion 22, and a bottom portion 24 that closes off another axial direction side of the tube wall portion 22. Note that the bottom portion 24 of the present exemplary embodiment configures part of the cover section 12. One axial direction side of the tube wall portion 22 opens upward (diagonally upward in the present exemplary embodiment), configuring the opening 26 of the pump casing section 20. Namely, the opening 26 of the pump casing section 20 of the present exemplary embodiment faces upward. Note that in the present exemplary embodiment, “upward” includes both diagonally upward and straight upward.

As illustrated in FIG. 2, an inner wall face 22A of the tube wall portion 22 is configured with an oval cross-section profile. A portion of the inner wall face 22A is contacted by an outer peripheral face 44A of the support portion 44 (described in detail later).

The tube wall portion 22 is formed with an intake portion 30, this being an opening for gas intake into the pump casing section 20. Configuration is made such that a check valve (not illustrated in the drawings) with a non-return function is connected to the intake portion 30. The intake portion 30 and the negative pressure-type brake booster (not illustrated in the drawings) are connected together through this check valve. Note that the check valve is configured so as to permit gas to flow from the negative pressure-type brake booster toward the intake portion 30, and prevent gas and oil from flowing from the intake portion 30 toward the negative pressure-type brake booster.

As illustrated in FIG. 2 and FIG. 4, the bottom portion 24 is provided with a circular hole portion 32 at a position offset with respect to the casing section center (the center of the tube wall portion 22 (the pump casing section 20)). The circular hole portion 32 penetrates the portion of the cover section 12 configuring the bottom portion 24. A shaft portion 42 of the rotation shaft 40 fits into the circular hole portion 32. An outer peripheral face 42A of the shaft portion 42 contacts a hole wall face 32A of the circular hole portion 32, such that the shaft portion 42 is rotatably supported by the hole wall face 32A.

The circular hole portion 32 of the present exemplary embodiment is formed by press-fitting a circular tube member 33 into a circular hole formed in the bottom portion 24. Namely, the hole wall face 32A of the circular hole portion 32 corresponds to an inner peripheral face of the circular tube member 33. The circular tube member 33 is formed from a resin with superior anti-abrasion properties to the resin used to form the pump casing section 20. Note that the present invention is not limited to the above configuration, and configuration may be made in which the shaft portion 42 of the rotation shaft 40 fits directly into a circular hole formed in the bottom portion 24.

A tube shaped portion 25 configuring part of the circular hole portion 32 is formed on the side of a back face 24B (a face opposite a bottom face 24A) of the bottom portion 24, namely on a back face side of the portion of the cover section 12 corresponding to the bottom portion 24.

The bottom portion 24 is formed with a discharge portion (not illustrated in the drawings), this being an opening for discharging oil inside the pump casing section 20 and gas that has been drawn in through the intake portion 30. The discharge portion is disposed further to the downstream side than the intake portion 30 in the vane 50 rotation direction. Note that the vane 50 of the present exemplary embodiment is configured to rotate counterclockwise as viewed from the lid body 38 side when negative pressure is generated.

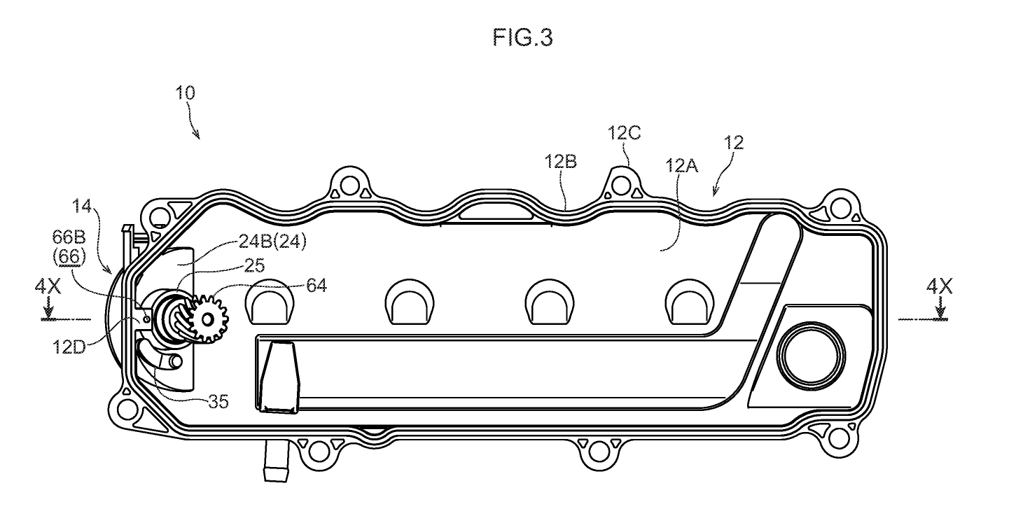

As illustrated in FIG. 3, a discharge portion 34 is closed off by a flexible discharge valve 35 that is attached to the back face 24B of the bottom portion 24. The discharge valve 35 is configured to permit gas and oil to flow from inside the pump casing section 20 toward the cylinder head 74 side, and to prevent gas and oil from flowing from the cylinder head 74 side toward into the pump casing section 20.

As illustrated in FIG1 and FIG. 2, the plate shaped lid body 38 is detachably mounted to the opening 26 of the pump casing section 20 (see FIG. 1). A sealing member (not illustrated in the drawings) is disposed at an abutting portion between the lid body 38 and the pump casing section 20. The sealing member prevents gas and oil inside the pump casing section 20 from leaking out between the lid body 38 and the pump casing section 20 in a state in which the lid body 38 is mounted to the pump casing section 20.

As illustrated in FIG. 4, in the present exemplary embodiment, a space inside the pump casing section 20 forms a pump chamber 36. Specifically, the pump chamber 36 is configured by the inner wall face 22A, the bottom face 24A, and a closing-off face 38A of the lid body 38.

As illustrated in FIG. 2 and FIG. 4, the pump casing section 20 is formed from resin, and is integrally formed together with the cover section 12. Specifically, an outer peripheral portion on the bottom portion 24 side of the tube wall portion 22 is integrated together with the top portion 12A and the peripheral wall portion 12B of the cover section 12 respectively.

The resin used to form the cover section 12 and the pump casing section 20 may be either a thermoset resin or a thermoplastic resin. Examples of thermoset resins include phenol-based resins, urea-based resins, melamine-based resins, epoxy-based resins, and polyamide-based resins. Examples of thermoplastic resins include urethane-based resins, olefin-based resins, vinyl-chloride-based resins, polyacetal-based resins, polyamide-based resins, and polyimide-based resins. Note that in the present exemplary embodiment, a ide-based resin (for example, nylon) is used as the resin to form the cover section 12 and the pump casing section 20, from the perspective of toughness and flexibility.

The lid body 38 is formed from resin, similarly to the pump casing section 20. The resin used to form the lid body 38 may be the same as, or different to, the resin used to form the pump casing section 20. In the present exemplary embodiment, the lid body 38 is formed from the same resin as the resin used to form the pump casing section 20.

In the present exemplary embodiment, the cover section 12, the pump casing section 20, and the lid body 38 are formed from resin; however the present invention is not limited thereto. The cover section 12, the pump casing section 20, and the lid body 38 may be formed from metal.

As illustrated in FIG. 4, the rotation shaft 40 extends in a direction intersecting with the cam shaft 76. As illustrated in FIG. 2 and FIG. 4, the rotation shaft 40 includes the shaft portion 42 that configures an axial direction intermediate portion of the rotation shaft 40 and fits rotatably into the circular hole portion 32, the support portion 44 that configures one axial direction end side of the rotation shaft 40 and is disposed inside the pump casing section 20, and a coupling portion 46 that configures another axial direction end side of the rotation shaft 40 and is coupled to the cam shaft 76. The shaft portion 42, the support portion 44, and the coupling portion 46 are coaxial to one another. In a state in which the shaft portion 42 is fitted into the circular hole portion 32, the center of rotation of the rotation shaft 40 is disposed at a position offset with respect to the center of the casing section (see FIG. 2).

The shaft portion 42 is configured in a circular column shape, and fits rotatably into the circular hole portion 32 of the pump casing section 20.

The support portion 44 is configured in a substantially circular tube shape, and has a larger diameter than the shaft portion 42. The support portion 44 is disposed inside the pump chamber 36 (inside the pump casing section 20), and the outer peripheral face 44A contacts a portion of the inner wall face 22A. Specifically, the outer peripheral face 44A of the support portion 44 slides against the portion of the inner wall face 22A in the vane rotation direction due to the rotation of the rotation shaft 40.

The support portion 44 is formed with a groove 45 extending in a direction intersecting with the axial direction of the rotation shaft 40, namely extending along the direction of a diameter of the rotation shaft 40. The groove 45 divides the support portion 44 in half.

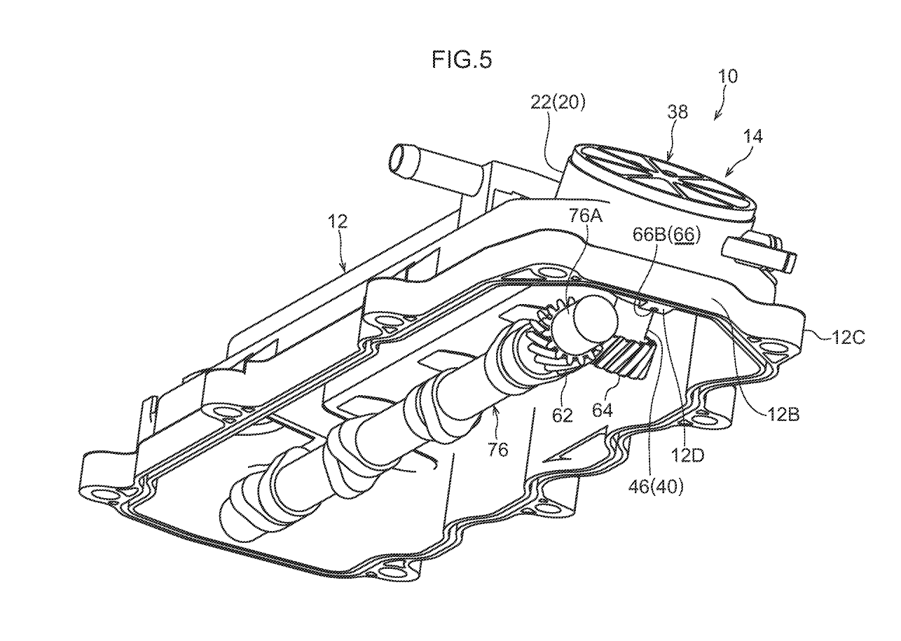

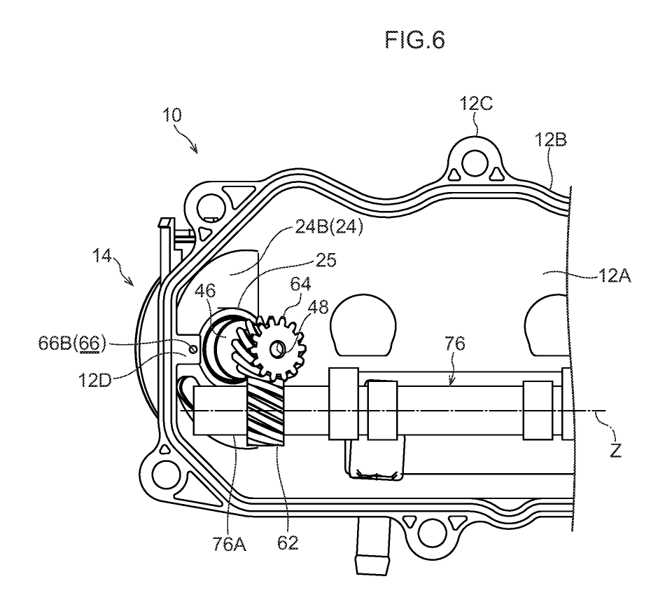

The coupling portion 46 is configured in a circular column shape, and is provided with a driven side gear 64 on an axial direction end portion side. The driven side gear 64 is configured so as to mesh with a drive side gear 62 provided on the side of an end portion 76A of the cam shaft 76 (see FIG. 5 and FIG. 6). The cam shaft 76 and the rotation shaft 40 are coupled together due to the driven side gear 64 meshing with the drive side gear 62. Motive power is transmitted from the cam shaft 76 to the rotation shaft 40 by coupling the cam shaft 76 and the rotation shaft 40 together in this manner.

As illustrated in FIG. 5 and FIG. 6, in the present exemplary embodiment, screw gears are employed for the drive side gear 62 and the driven side gear 64. Note that the present invention is not limited to this configuration, and bevel gears may be employed for the drive side gear 62 and the driven side gear 64.

The present invention is not limited to the above configuration, and other structures may be employed as long as motive power of the cam shaft 76 can be transmitted to the rotation shaft 40. For example, cogs and belts (or chains) may be employed to transmit motive power of the cam shaft 76 to the rotation shaft 40.

As illustrated in FIG. 4, the rotation shaft 40 is formed with a through hole 48 extending from the shaft portion 42 to a leading end of the coupling portion 46.

Since the rotation shaft 40 is a member for transmitting motive power of the engine 70 from the cam shaft 76, the rotation shaft 40 is formed from a metal material (for example steel) from the perspective of strength. Note that the rotation shaft 40 may be formed from resin, as long as sufficient strength can be secured.

Since the drive side gear 62 and the driven side gear 64 mesh together and transmit motive power from the cam shaft 76 to the rotation shaft 40, the drive side gear 62 and the driven side gear 64 are respectively formed from a metal material (for example iron) from the perspective of strength. Note that the drive side gear 62 and the driven side gear 64 may respectively be formed from resin, as long as sufficient strength can be secured.

As illustrated in FIG. 2 and FIG. 4, the plate shaped vane 50 is disposed inside the groove 45 of the support portion 44. The vane 50 is supported by groove walls 45A of the groove 45 such that both plate faces 50A are capable of moving reciprocally along a direction orthogonal to the rotation shaft 40 (in the direction of a diameter of the rotation shaft 40). The vane 50 accordingly rotates integrally with the rotation shaft 40.

The vane 50 rotates as a unit with the rotation shaft 40, such that two length direction end portions 50B moving reciprocally along the direction of a diameter of the rotation shaft 40 are pressed against the inner wall face 22A of the pump casing section 20 by centrifugal force, and slide across the inner wall face 22A. When this occurs, one width direction side portion 50C of the vane 50 slides across the closing-off face 38A of the lid body 38, and another width direction side portion 50D of the vane 50 slides across the bottom face 24A.

The vane 50 partitions the inside of the pump casing section 20 (the inside of the pump chamber 36) into plural spaces. The spaces partitioned by the vane 50 are configured so as to gradually decrease in volume on progression from the intake portion 30 side toward the discharge portion side. Namely, the spaces partitioned by the vane 50 change in volume with rotation of the vane 50.

In the present exemplary embodiment, the vane 50 is formed from resin; however, the present invention is not limited to such a configuration, and the vane 50 may be formed from metal.

As illustrated in FIG. 4 and FIG. 6, the oil supply path 66 extends from the pump casing section 20 to the cover section 12 and is in communication with an oil flow path 80 formed at the cylinder head 74. The oil supply path 66 is configured so as to supply oil pumped to the oil flow path 80 from the oil pump 78 to inside the pump casing section 20 (the pump chamber 36). Specifically, one end 66A of the oil supply path 66 opens onto the hole wall face 32A of the circular hole portion 32 (the inner peripheral face of the circular tube member 33), and the other end 66B of the oil supply path 66 opens onto an abutting portion between the cover section 12 and the cylinder head 74, namely the lower face 12D of the peripheral wall portion 12B.

The other end 66B of the oil supply path 66 is disposed at the lower face 12D of the cover section 12 so as to be in communication with the oil flow path 80 when the cover section 12 (the cylinder head cover 10) is attached to the upper portion of the cylinder head 74. Although not illustrated in the drawings, in the present exemplary embodiment, a sealing member (such as an oil seal) is disposed between the lower face 12D of the cover section 12 and the upper portion of the cylinder head 74. The seal member prevents oil from leaking out between the cylinder head 74 and the cover section 12 (the cylinder head cover 10).

As illustrated in FIG. 4, the oil supply path 66 of the present exemplary embodiment extends upward in a straight line from the lower face 12D of the cover section 12, and is configured by a through hole 67 that opens onto a circular hole formed in the bottom portion 24, and a through hole 68 that is formed at the circular tube member 33, and that is in communication with the through hole 67. Note that the through hole 67 configuring the oil supply path 66 extends upward in a straight line from the lower face 12D, and the opening 26 of the pump casing section 20 faces upward, thereby enabling the cylinder head cover 10 to be formed using a mold that is divided into a top and bottom with a simple structure.

Next, explanation follows regarding operation and advantageous effects of the cylinder head cover 10 according to the present exemplary embodiment.

In the cylinder head cover 10, when motive power (drive force) is transmitted from the cam shaft 76 to the rotation shaft 40, the vane 50 rotates integrally with the rotation shaft 40. Due to this rotation, the vane 50 moves along the direction orthogonal to the rotation shaft 40 (in the direction of a diameter of the rotation shaft) under centrifugal force, and the end portions 50B slide across the inner wall face 22A of the pump casing section 20. When this occurs, the one side portion 50C of the vane 50 slides across the closing-off face 38A of the lid body 38, and the other side portion 50D of the vane 50 slides across the bottom face 24A. Moreover, since the center of rotation of the rotation shaft 40 is disposed at a position offset with respect to the casing section center, the volume of the spaces partitioned by the vane 50 increases and decreases when the rotation shaft 40 and the vane 50 rotate together as a unit.

Accordingly, in each space partitioned by the vane 50, first, as the volume increases, gas is sucked in from the side of the negative pressure-type brake booster that is connected to the intake portion 30, thereby filling the space with gas. Next, as the volume decreases, the gas that has been taken in is discharged through the discharge portion (not illustrated in the drawings) while being compressed, thereby enabling negative pressure to be generated on the device side.

In the cylinder head cover 10, the opening 26 of the pump casing section 20 faces upward, and in a state in which the engine 70 is installed in the engine room, a large space above the engine can be utilized when performing an operation to couple the rotation shaft 40 to the cam shaft 76. This thereby facilitates a coupling operation of the rotation shaft 40 and the cam shaft 76.

In the cylinder head cover 10, oil pumped from the oil pump 78 toward the oil flow path 80 can be supplied inside the pump casing section 20 (the pump chamber 36) through the oil supply path 66 that extends from the pump casing section 20 to the cover section 12. This thereby enables oil to be supplied inside the pump casing section 20 with a simple structure.

The cylinder head cover 10 enables a reduction in manufacturing costs since the cover section 12 that covers the cylinder head 74 and the pump casing section 20 that configures the negative pressure pump section 14 are integrally formed together. Moreover, the cover section 12 and the pump casing section 20 are formed from resin, thereby enabling a reduction in weight while reducing manufacturing costs.

In the cylinder head cover 10, the one end 66A of the oil supply path 66 opens onto the hole wall face 32A of the circular hole portion 32. This thereby enables frictional resistance between the rotation shaft 40 and the circular hole portion 32 to be reduced, since oil is pumped between the outer peripheral face 42A of the shaft portion 42 and the hole wall face 32A of the circular hole portion 32. Wear between the rotation shaft 40 and the hole wall face 32A of the circular hole portion 32 is accordingly suppressed. Moreover, the oil smooths rotation of the rotation shaft 40, thereby suppressing energy loss in the engine 70. The other end 66B of the oil supply path 66 opens onto the lower face 12D, this being the portion of the cover section 12 that abuts the cylinder head 74. Accordingly, the oil supply path 66 and the oil flow path 80 of the cylinder head 74 can be placed in communication with each other by attaching the cover section 12 to the cylinder head 74.

In the cylinder head cover, motive power from the cam shaft 76 is transmitted to the rotation shaft 40 through the drive side gear 62 and the driven side gear 64 that are meshed together. Note that the rotation shaft 40 and the cam shaft 76 are coupled together by inserting the other axial direction end side of the rotation shaft 40 into the circular hole portion 32 of the pump casing section 20, and meshing the driven side gear 64 together with the drive side gear 62 of the cam shaft 76. This thereby further facilitates the operation to couple the rotation shaft 40 and the cam shaft 76 together.

As described above, the cylinder head cover 10 enables oil to be supplied inside the negative pressure pump section 14 (inside the pump chamber 36) with a simple structure, while facilitating the operation to couple the rotation shaft 40 configuring the negative pressure pump section 14 together with the cam shaft 76.

Note that in the present exemplary embodiment, the opening 26 of the pump casing section 20 has an upward (diagonally upward) facing orientation; however, the present invention is not limited to such a configuration. For example, the opening 26 of the pump casing section 20 may have an orientation facing directly upward. However, from the perspective of oil supply to, and oil expulsion from, the negative pressure pump section 14, the opening of the pump casing section 20 preferably faces diagonally upward.

In the present exemplary embodiment, the pump casing section 20 is formed to the outer peripheral edge portion of the top portion 12A of the cover section 12; however, the present invention is not limited thereto, and the pump casing section 20 may be formed to a central portion side of the top portion 12A of the cover section 12.

Detailed explanation has been given regarding a specific exemplary embodiment of the present invention; however, the present invention is not limited to this exemplary embodiment, and it would be obvious to a practitioner skilled in the art that various other exemplary embodiments are possible within the scope of the present invention.

Note that the disclosure of Japanese Patent Application No. 2013-241320, filed on Nov. 21, 2013, is incorporated in its entirety by reference herein.

All cited documents, patent applications and technical standards mentioned in the present specification are incorporated by reference in the present specification to the same extent as if the individual cited document, patent application, or technical standard was specifically and individually indicated to be incorporated by reference.

1. A cylinder head cover, comprising:
a cover section that covers a cylinder head of an engine provided with a cam shaft;
a pump casing section that has a bottomed tube shape, that is integrally formed with the cover section, that includes an upward-facing opening with the opening closed off by a lid body, and that is provided with a circular hole portion that penetrates the cover section at a position offset from a casing section center of a bottom portion;
a rotation shaft that fits into the circular hole portion, with one axial direction end side of the rotation shaft disposed inside the pump casing section and with another axial direction end side of the rotation shaft coupled to the cam shaft, and that is rotated by motive power transmitted from the cam shaft;
a vane that is disposed inside the pump casing section, that is supported by the rotation shaft so as to be capable of moving reciprocally along a direction orthogonal to the rotation shaft, that rotates integrally with the rotation shaft, that includes an end portion that slides across an inner wall face of the pump casing section, and that partitions the inside of the pump casing section into a plurality of spaces; and
an oil supply path that extends from the pump casing section to the cover section, that is in communication with an oil flow path formed at the cylinder head, and that supplies oil pumped to the oil flow path from an oil pump of the engine to inside the pump casing section.

2. The cylinder head cover of claim 1, wherein one end of the oil supply path opens onto a hole wall face of the circular hole portion, and another end of oil supply path opens onto a portion of the cover section that abuts the cylinder head and is in communication with the oil flow path.

3. The cylinder head cover of claim 1, wherein the other axial direction end side of the rotation shaft is provided with a driven side gear that meshes with a drive side gear provided at the cam shaft, and that couples the rotation shaft and the cam shaft together.
